(19) United States
(12) Patent Application Publication
(10) Pub. No.: US 2026/0233548 A1
(43) Pub. Date: Aug. 13, 2026

(54) SECURITY ELEMENT WITH TILT EFFECT

(71) Applicant: Giesecke+Devrient Currency Technology GmbH, Munchen (DE)

(72) Inventor: Christian FUHSE, Munchen (DE)

(21) Appl. No.: 19/535,058

(22) Filed: Feb. 10, 2026

(30) Foreign Application Priority Data
Feb. 12, 2025 (DE) 102025105082.1

(51) Int. Cl. B42D 25/328; G02B 26/08; G03H 1/00

(52) U.S. Cl. CPC B42D 25/328; G02B 26/0833; G02B 26/0841; G03H 1/0011

(57) ABSTRACT

A security element displays an alternating image to a viewer with at least two different views. The first view shows one motif, and the second view shows another, which appear in the same or overlapping zones. Each motif has a foreground region that appears bright and a surrounding background region that appears dark. Under directed illumination, tilting the security element about a first axis causes the first motif to appear only within a specific viewing angle range, and the second motif only within a different, non-overlapping range. The sheet-like pattern can be tilted about a second axis by at least 5°, without the first or second views disappearing or changing significantly. The bright foreground regions are ray-optically acting relief structures, specifically micromirror structures; the dark background regions are relief structures that absorb incident light and/or reflect it away from the intended viewing angles for the two views.

### BACKGROUND

The invention relates to a security element for security papers, value documents or the like that presents to a viewer an alternating image with at least two different views, with the first view showing a first motif and the second view showing a second motif, which appear in the same or at least overlapping zones.

Disclosed in the prior art are a multiplicity of security elements which on tilting show a viewer an image switch between two or more different motifs. Disclosed more particularly are tilt images which work on the basis of microlens arrays, and tilt images which are realized through diffraction gratings (often termed “holograms”) or micromirrors.

For an exceptionally efficient security element which even under difficult light conditions still enables unequivocal, rapid and exceptionally simple verification, important properties include the following:
1) high brightness and high contrast of the depiction,
2) rapid image switch and clear separation of the two or more images on tilting about the axis intended for verification,
3) exceptionally low sensitivity with regard to tilting about other axes, so that a viewer is not forced to first “seek out” the images by trialing a variety of tilt positions in respect of other tilt axes.

With a view to the property from point 1, micromirror-based security elements are deserving of particular preference: with highly directed reflection, relative to lens-based or hologram-based security elements, they are able to provide more brightness and better contrast.

One comparatively simple micromirror-based tilt image is known from EP 0868313 A1. In that case, the micromirrors belonging to one depiction each have fixed orientations and the background regions are, for example, flat (with no relief structure) or occupied by diffraction structures or matt structures. The fixed or uniform orientation of the micromirrors of one depiction provides very high brightness, which can be observed in particular under directed illumination, but only in a small tilt angle range. Furthermore, background regions without relief structures or occupied by matt structures also often appear bright, so detracting from optimal contrast between tilt image depictions and the background. In addition, if the background is lit up (for example, with a flat background, bright lighting-up in the mirror reflection, or, with diffraction structures, a lighting-up in rainbow colors over a relatively large angular range), this may cause disruption in particular between the lighting-up of two tilt views.

A larger viewing angle range and less disruptive background can be achieved with tilt effects which show depictions that appear to be arched, as known from DE 10 2012 020 257 A1. Overall, however, depictions of this kind do not appear with such great brightness, do not exhibit abrupt appearance and disappearance on tilting, and often also have only little contrast with the background.

### SUMMARY

The object of the invention in particular, therefore, is to provide a security element which in particular fulfills the above-stated properties of points 1 to 3 more effectively and simultaneously than the solutions known from the prior art.

To illustrate the various tilt axes, a distinction will be made here and below between north-south tilting and east-west tilting; see FIG. 1. North-south tilting (left-hand diagram) is understood to mean that a viewer performs tilting about the transverse axis Q, whereas east-west tilting (right-hand diagram) refers to tilting about the vertical axis H, as outlined in FIG. 1. It is envisaged in each case that a viewer views the image switch on north-south tilting, with the tilt image remaining substantially maintained and unaltered, in a sufficiently large viewing angle range, on tilting east-west. The purpose of the latter is to allow the depictions to be seen readily even under highly directed illumination, without it being necessary to find a narrow envisaged angular range exactly in east-west direction.

The subject of the invention can of course also be designed in principle for other tilt axes, i.e., for example, for a tilt on east-west tilting with a large viewing angle range in north-south, or for a tilt about a different axis (for example, northwest/southeast or other axes).

In this case, the security element, in the form of an optically variable sheetlike pattern, provides a viewer with a tilt image having at least two different views, the two views each showing a bright foreground and a dark background. The foreground regions here are generated with reflective microstructures, more particularly with micromirror arrangements. The micromirrors here are oriented such that the micromirrors belonging to the same view each reflect light in a spatial angle range which is different with respect to a first tilt axis (in the exemplary embodiments, north-south tilting). Here, the tilt angle ranges are non-overlapping, preferably spaced apart from one another, and/or each cover only a relatively small tilt angle range, in which the corresponding depiction lights up very brightly. With respect to a second tilt direction (in the exemplary embodiments, east-west tilting), however, in accordance with the invention, the angular range covered is to be at least large enough that a viewer can perform tilting about this axis relatively widely, without the view changing or even disappearing. Accordingly, in the case of light which is incident in a highly directed way, the view is intended not to change or not to disappear in a tilt angle range of at least 5°, preferably at least 10° and more preferably at least 20°. The widening of the tilt angle range in this direction can be accomplished, when using micromirrors having a substantially planar surface, by random variation of the corresponding mirror orientation component, or alternatively by using mirrors which are curved at least in this direction and which correspondingly fan out the reflected light in this direction.

A security element of the invention is passive in the sense that it does not itself shine or generate light, but only reflects incident ambient light in regionally different directions. Accordingly, in an entirely dark environment, it would be completely dark. The terms “bright” and “dark” are to be understood here, therefore, to mean that in a typical viewing situation (for example, in a room with ceiling lighting or with light incident through a window), the microstructures in “bright” regions reflect a lot of light from the environment in the direction of the eyes of a viewer, whereas less ambient light is reflected into the eyes of the viewer from “dark” regions. “Bright” and “dark” here are meant in particular in relation to one another. The actual brightness or darkness of the security element is dependent on the ambient light conditions. The contrast enabled by the subject of the invention, i.e., the differences between “bright” and “dark”, is also dependent on the ambient light conditions, as is likewise the case with other reflective security elements in the prior art. Accordingly, the contrast between “bright” and “dark” regions is typically higher under highly directed lighting than in diffuse light. In relation to the subject of the invention, the term “light up” is also to be understood in this sense, to mean that a particularly large amount of incident light is reflected to the viewer, relative to security elements of the prior art.

The bright regions of the first and second views are intended to overlap, allowing a tilt image with image switch to be realized at the same location. For this purpose, the micromirrors of the two views may be interspersed in one another within one embossment plane or alternatively may be provided in planes one above another. One particularly advantageous construction with two embossment planes is known in particular from DE 10 2020 000 732 A1. In specific embodiments, provision may also be made here for the micromirrors belonging to different views to reflect the incident light in different colors; consequently, the two views present the different motifs in different colors, which further reinforces the tilt effect. Color switches of this kind may be realized by constructions having two embossment planes, as known, for example, from DE 10 2020 000 732 A1, or by virtue of the color of the light reflected at the micromirrors being altered by means of nanostructures superimposed on the mirrors (more particularly regular or irregular subwave structures having structure spacings or periods of, for example, 50 nm to 600 nm, preferably 200 nm to 400 nm). The nanostructures here may generate colors in combination, for example, with a simple metallization (for example, aluminum coating), more particularly by plasmon effects, or, in combination with an interference coating (a “color shift” coating with reflector/dielectric/absorber—for example, construction with Al/SiO₂/Cr), may alter the color of the interference coating.

The backgrounds of the first and second views, respectively, these backgrounds having a dark or non-bright appearance, are occupied by relief structures which appear dark at many and preferably all tilt directions, advantageously in particular in the entire viewing angle range between and within the angular ranges of the first and second depictions. The following may be used advantageously for this purpose:
micromirrors which in respect of the first and/or second tilt direction have a greater inclination than the micromirrors of the bright foregrounds, so that they deflect incident light more strongly or at least in markedly different directions than the mirrors which provide the bright foregrounds,
light-trapping structures, including in particular those with dimensions in the subwavelength range (lower than the wavelength of visible light), examples being subwavelength structures referred to as “motheye structures” or “diffractive black”, preferably metallized and consisting of periodic gratings or aperiodic arrangements, more particularly having a high aspect ratio, i.e., a high ratio of structure height to depth, or
other light-trapping structures, having dimensions above the “subwavelength range”, more particularly with a structure size of about 0.5 μm to preferably not more than 20 μm, examples being light-trapping “microcavities”.

This combination ensures that the tilt effect, relative to unwanted tilts in respect of the east-west axis (more generally: second tilt axis), always shows a high-contrast tilt effect in the case of north-south tilting (more generally: first tilt axis). The preferred embodiments of the background, moreover, ensure that tilting from the first to the second tilt view is not accompanied by any disruptive effects such as a background which suddenly lights up brightly.

According to a further advantageous configuration of the security element, the ray-optically acting relief structures belonging to the bright regions of the first and second motifs, respectively, are interspersed in one another and the interspersion is preferably implemented on a length scale so small that without means of assistance it cannot be resolved by the human eye; more particularly, the interspersion is realized via division into pixels or stripes having dimensions of less than 100 μm and advantageously less than 50 μm.

According to a further advantageous configuration of the security element, the ray-optically acting relief structures belonging to the bright regions of the first and second motifs, respectively, are micromirrors having a substantially straight surface, with each individual micromirror, under directed illumination, reflecting incident light substantially only in one direction, and visibility of the first and second motifs, respectively, in the intended viewing angle range with respect to the first tilt axis, on tilting by 5°, preferably by 10° or more preferably by 20° about the second axis, is maintained by virtue of the individual micromirrors having multiple different orientations which differ in particular in the component belonging to the second tilt axis, so that the light reflected at the entirety of the micromirrors is fanned out into a correspondingly larger angular range.

According to a further advantageous configuration of the security element, the component of the micromirror orientations that belongs to the second tilt axis is chosen randomly or pseudo-randomly from a specified range.

According to a further advantageous configuration of the security element, the ray-optically acting relief structures belonging to the bright regions of the first and second motifs, respectively, are micromirrors having a curved surface, which under directed illumination fan out incident light such that, with respect to the second tilt axis, an angular range of at least 5°, preferably at least 10° and more preferably at least 20°is covered.

According to a further advantageous configuration of the security element, light-trapping micro-or nanostructures, more particularly periodic or aperiodic motheye structures, are provided in the dark background regions.

According to a further advantageous configuration of the security element, reflective micromirrors having a curved or straight surface, which exhibit an at least 10%, preferably at least 50% higher slope than the micromirrors belonging to the foreground regions, are provided in the dark background regions.

According to a further advantageous configuration of the security element, either the foreground regions of the two motifs or the foreground and background regions of at least one motif have a different hue. In this case, preferably, the different hues are generated by nanostructures superimposed on the ray-optically acting relief structures.

According to a further advantageous configuration of the security element, the micromirrors are provided with a color-shifting coating.

According to a further advantageous configuration of the security element, the ray-optically reflective relief structures belonging to the foreground of the first and second motifs, respectively, are present in two different embossment planes that are spaced apart from one another, with the light reflected by the relief structures in the first and second embossment planes, respectively, having preferably different hues.

According to a further advantageous configuration of the security element, the zone of the first and second views is surrounded with a frame having an arched appearance, and the arching effect of the frame is realized through reflective, substantially ray-optically acting relief structures which mimic the reflection characteristics of an arched metallic surface. In this case, preferably, the frame accommodates two arching effects which are interspersed in one another, which are visible in different tilt angle ranges on tilting about the first axis, and which show the same or different frames having an arched appearance, with the tilt angle range of the first arching effect embracing the first tilt angle range, in which the first motif is visible, and the tilt angle range of the second arching effect embracing the second tilt angle range of the second motif, so that a viewer sees the first or second motif in each case with a frame which is visible in the same viewing angle range or which is lit up and has an arched appearance.

Value documents for which a security element of the invention may be used are, more particularly, banknotes, shares, bonds, certificates, vouchers, checks, high-value admission tickets, and also other papers at risk of being counterfeited, such as passports and other identity documents, and also cards, such as credit or debit cards, for example, whose card body includes at least one ply of a security paper, and also product safeguarding elements, such as labels, seals, packaging, folding boxes, pack inserts, and the like. The simplified designation “value document” includes all of the above-stated materials, documents, and product safeguarding means.

It will be appreciated that the features stated above and those yet to be elucidated below may be employed not only in the combinations indicated but also in other combinations, without departing the ambit of the present invention, in so far as this is within the scope of protection of the claims.

### BRIEF DESCRIPTION OF THE DRAWINGS

The advantages of the invention are elucidated with reference to the exemplary embodiments below and to the supplementary figures. The exemplary embodiments constitute preferred embodiments, but without any intention at all for the invention to be confined to them. Furthermore, for greater ease of understanding, the representations in the figures are highly schematized and do not reflect the actual circumstances. In particular, the proportions shown in the figures do not match the conditions present in reality, and serve solely to improve clearness. Furthermore, the embodiments described in the exemplary embodiments below are reduced to the essential core information, for greater ease of understanding. In the practical implementation, substantially more complex patterns or images may be employed.

In detail and schematically,

FIG. 1 shows the two different tilt directions, for illustration,

FIG. 2 shows in plan view a security element of the invention as viewed from a first tilt angle range (100) and as viewed from a second tilt angle range (200) in respect of a first tilt axis,

FIG. 3 shows in plan view a security element of the invention for which the tilt effect from FIG. 2 is combined with a different tilt effect, more particularly with an arch-tilt effect,

FIG. 4 shows in plan view a security element of the invention for which the tilt effect is implemented with more than one color.

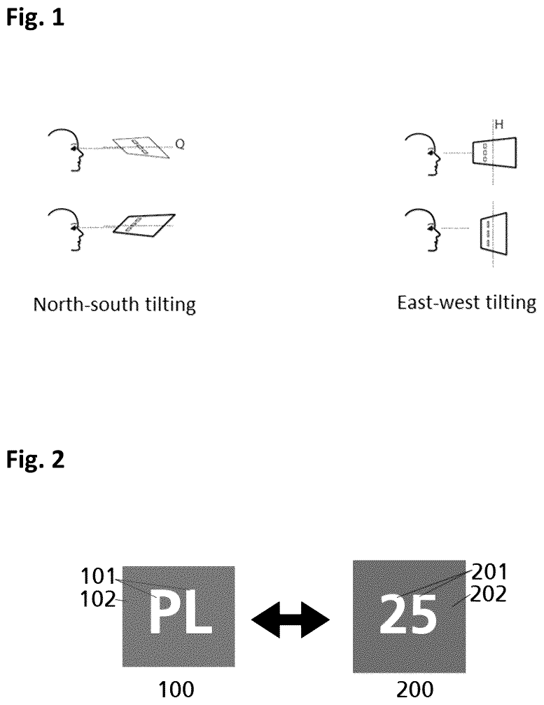

### DETAILED DESCRIPTION OF VARIOUS EMBODIMENTS

FIG. 2 shows a security element of the invention as viewed from a first tilt angle range (100) and as viewed from a second tilt angle range (200) in respect of a first tilt axis. The image switch between 100 and 200 could take place, for example, on north-south tilting by an angle for example of 20°.

Typical dimensions of such depictions, with the present-day security elements (security threads, security strips, patches), are a few or several millimeters. A viewer here sees the letters “PL” light up brightly in the first tilt angle range and the number “25” light up brightly in the second tilt position. The depictions each consist of a bright foreground (101, 201) and a dark background (102, 202).

One possible realization of the bright regions lies in the use of micromirrors. The latter may have dimensions of, for example, 3 μm to 100 μm, preferably 5 μm to about 20 μm. For a tilt effect about the north-south axis, for example, the mirrors of the foreground 101 may be inclined to the “north” (i.e., upward) and the mirrors of the foreground 201 to the “south”, so that depending on the tilt position, only one kind of the mirrors lights up brightly and the other mirrors, correspondingly, are dark and are barely recognizably or entirely unrecognizably distinct from the dark background. For all the micromirrors of the foreground 101 or for all the micro-mirrors of the foreground 201, the inclination in north-south direction may in each case be exactly the same or may vary within a specified range. For example, all mirrors of the depiction 101 may be inclined by 10° to the north and all mirrors for 201 may be inclined by 10° to the south. Accordingly, on north-south tilting, a very bright but also very short (only in a narrow tilt angle range) visible lighting-up would be realized. In other embodiments, the values may also vary around the respective middle value, thus being chosen, for example, from a range from 5° to 15° or −15° to −5°. Generally speaking, the skilled person is able, by choosing the middle orientation, to adjust the extent to which tilting must be performed for the image switch to be observed, and the size of the respective range then has an influence on the brightness and “display time” of the depiction on tilting. For maximum clarity of separation (in contrast to slow “cross-fading”) of the views 100 and 200, the angular ranges of the north-south components of the mirrors of the foregrounds 101 and 201 ought as far as possible not to overlap; preferably, indeed, they are separate from one another at least by several degrees (at least 3°, more preferably at least 5°).

So that the views are maintained even on small or else, advantageously, relatively large tilts in east-west direction, the mirrors may, for example, also have an inclination component in east-west direction. This component may in particular be chosen randomly or pseudo-randomly, so that always a portion of the mirrors light up brightly within a certain tilting range in respect of this axis. The smaller the micromirrors, the more effectively it is possible here to achieve a largely uniform brightness over numerous angles. The larger the mirrors become, the more likely the differently lighting-up mirrors are to be visible with the naked eye as well-however, this need not be a negative and may also be perceived, for example, as “glitter effects”.

Owing to the overlapping of the foreground motifs 101 and 201, the associated micromirrors are arranged interspersed in one another. This interspersion is preferably implemented on a length scale below the resolution capacity of the human eye; for example, the regions of the micromirrors for 101 and 201, respectively, may be present in a chessboard or stripe segmentation, in which the fields or stripes may have dimensions of between 10 μm and about 100 μm.

In the background regions 202, 102 there may likewise be micromirrors present. In the north-south and/or east-west directions, these micromirrors may preferably have a substantially greater inclination than the micromirrors of the foreground regions 101, 201. In the example stated above, with north-south slope components of +/−10°, the background mirrors could for example have double the slope components (i.e., +/−20°). Similarly, in the east-west direction for the mirrors 101, 201, a variation range from −10° to +10° could be provided, while the corresponding inclination components in the regions 202, 102 may for example be +20° and/or −20°. The mirrors in the background regions may all have the same or different orientations. Advantageous in practice, for example, are arrangements having four different orientations, in which the mirrors are aligned to a very great extent (as far as technical limitations allow) in northeast, northwest, southeast, and southwest directions. Accordingly, the background would light up brightly only if the viewer tilts a security element about both tilt directions to a maximum extent from the middle position, and even then only some of the mirrors (in this case, a quarter) would light up.

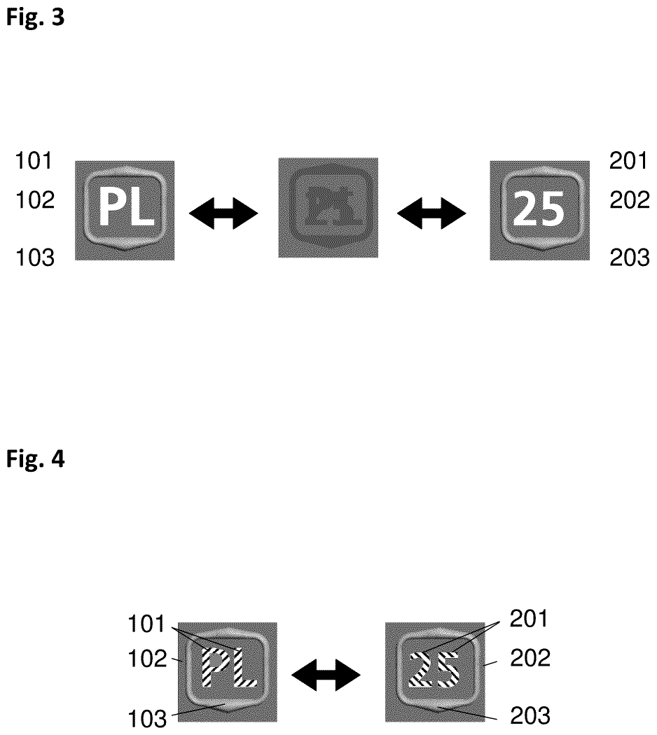

FIG. 3 shows a security element of the invention for which the tilt effect from FIG. 2 is combined with a different tilt effect, more particularly with an arch-tilt effect, as known from DE 10 2012 020 257 A1. It has emerged in this case that an arch-tilt effect of this kind is also able very well to provide a frame with an arched appearance around the tilt effect of the invention. At the corresponding tilt angles in respect of the first tilt axis, a frame with an arched appearance may become visible on tilting. For the first and second views, this frame may have a different shape or else, in particular, the same shape. The latter is virtually an arch-tilt effect “in itself” and has the advantage over a standard arch effect that the frame may in each case be brightly visible only when the associated tilt of the invention is also visible. On tilting about the first axis, a viewer then sees the following image sequence, where 103 and 203 denote the arched frames visible in each case, which here each show an identical appearance (“arch-tilt in itself”), whereas, in an intermediate position, the tilt in the middle and the frame are dark. In addition to the frame, different or additional arch-tilt elements may also be provided.

FIG. 4 shows a security element of the invention wherein the tilt effect is implemented with more than one color. The color plurality may be realized in particular, as described above, by means of nanostructures on the micromirrors. Alternatively, it may also be realized with two embossment planes, as known in particular from DE 10 2020 000 732 A1. In this case, the mirrors for 101 and 201 lie in different embossment planes and do not have to be interspersed within a plane. In an embodiment with nanostructures, for example, the micromirrors for 101 may be provided with nanostructures of blue appearance and the micromirrors for 201 with nanostructures of yellow appearance. Additionally or alternatively, the frame regions 103, 203 may also have different-colored or same-colored nanostructures (here: both red in each case) superimposed on them.

In other embodiments, the foreground regions 101, 201 may also have the same color, but at least one of the background regions 102, 202 or frames 103, 203 may have a color differing from the color of the regions 101, 102.

1. A security element for security papers or value documents that presents to a viewer an alternating image with at least two different views, with the first view showing a first motif and the second view showing a second motif, which appear in the same or at least overlapping zones, wherein
the first and second motifs each consist of a foreground region which appears bright and a background region which surrounds this foreground region and appears dark,
under directed illumination, on the tilting of the security element about a first axis, the first motif appears only in a first viewing angle range and the second motif only in a second viewing angle range, with the two viewing angle ranges being different and not overlapping,
in the first and second viewing angle ranges, respectively, the sheetlike pattern can be tilted about a second axis in an angular range of at least 5°, without the first and second views, respectively, disappearing or undergoing substantial alteration,
the bright foreground regions of the two motifs are ray-optically acting relief structures, more particularly micromirror structures,
the dark background regions are relief structures which absorb the incident light and/or reflect the incident light in directions outside the viewing angle ranges intended for the two views.

2. The security element according to claim 1, wherein the ray-optically acting relief structures belonging to the bright regions of the first and second motifs, respectively, are interspersed in one another and the interspersion is implemented on a length scale so small that without means of assistance it cannot be resolved by the human eye; more particularly, the interspersion is realized via division into pixels or stripes having dimensions of less than 100 μm.

3. The security element according to claim 1, wherein the ray-optically acting relief structures belonging to the bright regions of the first and second motifs, respectively, are micromirrors having a substantially straight surface, with each individual micromirror, under directed illumination, reflecting incident light substantially only in one direction, and visibility of the first and second motifs, respectively, in the intended viewing angle range with respect to the first tilt axis, on tilting by 5° about the second axis, is maintained by virtue of the individual micromirrors having multiple different orientations which differ in particular in the component belonging to the second tilt axis, so that the light reflected at the entirety of the micromirrors is fanned out into a correspondingly larger angular range.

4. The security element according to claim 1, wherein the component of the micromirror orientations that belongs to the second tilt axis is chosen randomly or pseudo-randomly from a specified range.

5. The security element according to claim 1, wherein the ray-optically acting relief structures belonging to the bright regions of the first and second motifs, respectively, are micromirrors having a curved surface, which under directed illumination fan out incident light such that, with respect to the second tilt axis, an angular range of at least 5° is covered.

6. The security element according to claim 1, wherein light-trapping micro-or nanostructures, more particularly periodic or aperiodic motheye structures, are provided in the dark background regions.

7. The security element according to claim 1, wherein reflective micromirrors having a curved or straight surface, which exhibit an at least 10% higher slope than the micromirrors belonging to the foreground regions, are provided in the dark background regions.

8. The security element according to claim 1, wherein either the foreground regions of the two motifs or the foreground and background regions of at least one motif have a different hue.

9. The security element according to claim 8, wherein the different hues are generated by nanostructures superimposed on the ray-optically acting relief structures.

10. The security element according to claim 1, wherein the micromirrors are provided with a color-shifting coating.

11. The security element according to claim 1, wherein the ray-optically reflective relief structures belonging to the foreground of the first and second motifs, respectively, are present in two different embossment planes that are spaced apart from one another, with the light reflected by the relief structures in the first and second embossment planes, respectively, having different hues.

12. The security element according to claim 1, wherein the zone of the first and second views is surrounded with a frame having an arched appearance, and the arching effect of the frame is realized through reflective, substantially ray-optically acting relief structures which mimic the reflection characteristics of an arched metallic surface.

13. The security element according to claim 12, wherein the frame accommodates two arching effects which are interspersed in one another, which are visible in different tilt angle ranges on tilting about the first axis, and which show the same or different frames having an arched appearance, with the tilt angle range of the first arching effect embracing the first tilt angle range, in which the first motif is visible, and the tilt angle range of the second arching effect embracing the second tilt angle range of the second motif, so that a viewer sees the first or second motif in each case with a frame which is visible in the same viewing angle range or which is lit up and has an arched appearance.
